(19) United States
(12) Patent Application Publication
(10) Pub. No.: US 2025/0111550 A1
(43) Pub. Date: Apr. 3, 2025

(54) USING TEXT-TO-IMAGE MODEL(S) TO GENERATE SYNTHETIC IMAGES FOR TRAINING ANOMALY DETECTION MODEL(S)

(71) Applicant: Yokogawa Electric Corporation, Tokyo (JP)

(72) Inventor: Dakota Mahan, Carrollton, TX (US)

(21) Appl. No.: 18/385,050

(22) Filed: Oct. 30, 2023

Related U.S. Application Data
(60) Provisional application No. 63/542,214, filed on Oct. 3, 2023.

(51) Int. Cl. G06T 11/00; B25J 9/16; G06V 20/70

(52) U.S. Cl. CPC G06T 11/00; B25J 9/1697; G06V 20/70

(57) ABSTRACT

Implementations are described herein for monitoring and detecting anomalies for an industrial facility component based on ML-based image processing. In various implementations, multiple text strings each describing an anomaly within an industrial facility setting are determined, and for each of the multiple text strings, multiple iterations of processing the text string are performed using a text-to-image model, to generate a corresponding synthetic image at each of the iterations. The generated synthetic images can be utilized to train an anomaly detection machine learning (ML) model, or to fine-tune or validate a trained anomaly detection ML model.

### BACKGROUND

Complex industrial facility such as a petrochemical refinery, chemical plant, etc., can include numerous components that are utilized in the processing of liquid(s) and/or of other matter(s) involved in the industrial process(es) of the industrial facility. To ensure that the components involved in the industrial process(es) are operating as intended and/or to ensure that matter(s) involved in the industrial process(es) are in their intended states, it is important to monitor for anomalies (e.g., presence of oil or other liquid on the ground, corrosion of pipes, etc.) in industrial facilities, so that one or more remediating actions (e.g., alerting, halting automated process(s), etc.) can be timely performed when anomaly is detected.

### SUMMARY

Various techniques have been proposed for processing an image, using a machine learning (ML) model, to generate output that indicates whether condition(s) are present in the image. For example, techniques have been proposed for processing an image capturing one or more components of an industrial facility, using an anomaly detection ML model (sometimes referred to herein as an “anomaly detection model”), to generate output that indicates whether an anomaly is present in the one or more components captured by the image. However, to be effective and have a satisfactory accuracy in prediction, the anomaly detection ML model must be trained based on a large quantity of diverse “positive” ground truth images that each reflect the presence of a corresponding anomaly.

Separately, text-to-image models have been released that enable providing of a text prompt, and generation of a detailed and realistic synthetic image that is conditioned on the text prompt. For example, a text prompt of “an orange cat riding a donkey” can be processed to generate a realistic synthetic image that includes an orange cat that is riding a donkey. Some of those models also enable image-to-image translations that are conditioned on a text prompt. For example, a base image that includes a black cat can be provided along with a prompt of “make the cat orange”, and a translated synthetic image generated that includes an orange cat in lieu of a black cat-but otherwise generally conforms to the base image. Non-limiting examples of text-to-image and image-to-image models (many models can do both) include “Stable Diffusion” and “DALL-E”.

As referenced above, to be effective, an anomaly detection ML model must be trained based on a large quantity of diverse “positive” ground truth images that each reflect the presence of a corresponding anomaly. Obtaining such a large quantity of diverse real-life images in the industrial facility setting can be difficult since corresponding anomalies infrequently occur and/or can be hazardous.

Further, prior to utilization of such an anomaly detection ML model in a particular industrial facility, there is no current way to (a) fine-tune the model to the particular industrial facility and/or to (b) validate performance of the model in detecting anomalies within the industrial facility. For example, with respect to (a), fine-tuning (i.e., limited additional training) of an anomaly detection ML model for the particular industrial facility can not be possible since obtaining “positive” ground truth real images, that capture an anomaly and that are particularized for the industrial facility, can be difficult. For instance, it can not be safe or desirable to create such an anomaly in the industrial facility. Also, for instance, the industrial facility can be constructed but not yet in active use. As another example, and with respect to (b), it can likewise not be possible to validate that an anomaly detection ML model is effective for the particular industrial facility in advance of utilization of the an anomaly detection ML model in the particular facility. This can be due to such validation requiring determining that the ML model is able to detect occurrence of anomalies in the particular facility. Again, actually creating anomalies in the particular facility can be unsafe or undesirable.

Implementations disclosed herein enable generation of a large quantity of synthetic diverse “positive” ground truth images that each reflect the presence of a corresponding anomaly within an industrial facility. Those implementations generate the synthetic images using a text-to-image model. More particularly, they prompt the text-to-image model with prompt(s) that describe the anomaly and that describe an industrial facility setting, resulting in images that include the anomaly and that are in the industrial facility setting. For example, a prompt of “exterior of chemical plant with oil puddles” and/or a prompt of “interior of a chemical plant with oil on floor”. It is noted that those implementations can generate multiple distinct synthetic images by processing the same prompt multiple times. Although the same prompt is used at each iteration, different synthetic images will be generated as a different “seed’ is randomly utilized by the model at each iteration.

Implementations disclosed herein additionally or alternatively enable generation of synthetic diverse “positive” ground truth images that each reflect the presence of a corresponding anomaly within an industrial facility, and that are each for a particular industrial facility. This enables such particularized images to be used to (a) fine-tune the ML model prior to its utilization with the particular industrial facility (which can improve accuracy and/or robustness) and/or (b) validate the ML model prior to its utilization with the particular industrial facility (to ensure it will be effective for the particular industrial facility).

Those implementations can capture real images of the particular industrial facility, then process those real images using an image-to-image translation model conditioned on a text prompt that describes the anomaly. For example, processing a real image, along with a text prompt of “add an oil puddle”, can result in a synthetic image that substantially conforms to the real image, but includes an oil puddle on the ground. As a particular example, hundreds or thousands of real images of the particular industrial facility can be captured (e.g., by a robot) while the industrial facility is free of anomalies. Those real images can then be processed using the image-to-image model, conditioned on a text prompt that describes the anomaly, to generate corresponding synthetic images that include the anomaly. Those corresponding synthetic images can then be used for fine-tuning and/or validation as described herein.

Implementations generate, using a text-to-image model, a large quantity of synthetic diverse “positive” ground truth images that each reflect the presence of a corresponding anomaly within an industrial facility. More particularly, they prompt the text-to-image model with prompt(s) that describe the anomaly and that describe an industrial facility setting, resulting in images that include the anomaly and that are in the industrial facility setting. For example, a prompt of “chemical plant room with pipes that include corrosion”. Some of those implementations can also generate, using anomaly-free real images from industrial facilities and an image-to-image translation model, additional synthetic “positive” ground truth images. For example, an anomaly-free real image can be processed, along with a prompt of “add some corrosion”, to generate a synthetic image that conforms to the real image, but includes some corrosion on object(s) in the image.

The generated synthetic ground truth images can then optionally be labeled (e.g., by human reviewers). For example, each label can indicate whether or not an anomaly is present in the image and, optionally, an area in which the anomaly occurs and/or a type of the anomaly. The synthetic ground truth images and their labels can then be used to train an anomaly detection ML model. The anomaly detection ML model can then be utilized for anomaly detection in an industrial facility.

Some implementations additionally or alternatively generate translated synthetic diverse “positive” ground truth images that each reflect the presence of a corresponding anomaly within an industrial facility, and that are each for a particular industrial facility. This enables such particularized images to be used to (a) fine-tune the anomaly detection ML model prior to its utilization with the particular industrial facility (which can improve accuracy and/or robustness) and/or (b) validate the anomaly detection ML model prior to its utilization with the particular industrial facility (to ensure it will be effective for the particular industrial facility).

Those implementations can capture real images of the particular industrial facility, then process those real images using an image-to-image translation model conditioned on a text prompt that describes the anomaly. For example, processing a real image, along with a text prompt of “add corrosion to one component”, can result in a translated synthetic image that substantially conforms to the real image, but includes corrosion on a component of the image. As a particular example, hundreds or thousands of real images of the particular industrial facility can be captured (e.g., by a robot) while the industrial facility is free of anomalies. Those real images can then be processed using the image-to-image model, conditioned on a text prompt that describes the anomaly, to generate corresponding translated synthetic images that include the anomaly. Those corresponding translated synthetic images can then be used for fine-tuning and/or validation.

For example, in validating the anomaly detection ML model for a particular industrial facility, the translated synthetic images can each be processed using the anomaly detection ML model to generate corresponding output that indicates whether an anomaly is present. Those corresponding outputs can then be compared to ground truth outputs (that indicate whether an anomaly actually is present in the corresponding translated synthetic image) to generate an accuracy measure for the outputs (e.g., 90% if 900 of 1000 predictions were correct). Optionally, the anomaly detection ML model will only be deployed for use, within the particular industrial facility, if the accuracy measure and/or other validation measure(s) satisfy threshold(s).

In various implementations, a method implemented by processor(s) is provided and includes, for each of multiple text strings that each describe an anomaly and a corresponding industrial facility setting: performing multiple iterations of processing the text string, using a text-to-image model, to generate a corresponding synthetic image (e.g., conditioned on the text string) at each of the iterations.

The industrial facility setting can include an industrial automation facility that implements any number of at least partially automated processes. For example, an industrial automation facility can take the form of a chemical processing plant, an oil or natural gas refinery, a catalyst factory, a manufacturing facility, an offshore oil platform, or any other applicable industrial environment.

The multiple text strings can each describe an anomaly presented in one of the one or more components within the industrial facility setting. For example, different text strings can describe different anomalies for the same component within or surrounding the industrial facility setting. As another example, different text strings can describe different anomalies for different components within or surrounding the industrial facility setting. As yet another example, different text strings can describe different anomalies for different components within different industrial facility settings. A synthetic image can be a detailed and realistic image capturing presence of a respective anomaly in one or more components within or surrounding the industrial facility setting.

In various implementations, the method can further include training an anomaly detection machine learning (ML) model using the generated synthetic images and corresponding supervised labels for the generated synthetic images. For example, for a synthetic image M₁₋₁ generated at a first iteration using a first text string (that describes or indicates a first anomaly in association with a component within or surrounding the corresponding industrial facility setting), a label L₁₋₁ can be generated. The label L1-1 can be generated automatically based on the first text string, or can be generated (or examined) manually by a human technician or expert trained to identify labels for objects within the industrial facility setting. In this example, the synthetic image M₁₋₁ can be applied as a training instance input, to be processed using the anomaly detection ML model, to generate a corresponding output indicating, e.g., a type, a name, and/or a location (which can be highlighted using a bounding box) of a corresponding anomaly A₁₋₁. The corresponding output can then be compared with the label L₁₋₁ (which is considered as a ground truth label describing the ground truth type, name, and/or location of the anomaly A1-1) to determine a difference, and one or more parameters/weights of the anomaly detection ML mode can be adjusted based on the difference. Similarly, for a synthetic image M₁₋₂ generated at a second iteration using the first text string, a label L₁₋₂ can be generated. The synthetic image M₁₋₂ can be applied as a training instance input, to be processed using the anomaly detection ML model, to generate a corresponding output indicating, e.g., a type, a name, and/or a location (which can be highlighted using a bounding box) a corresponding anomaly A₁₋₂. The corresponding output can then be compared with the label L₁₋₂, to determine an additional difference, and one or more of the parameters of the anomaly detection ML mode can be adjusted based on the additional difference.

Alternatively or additionally, for a synthetic image M₂₋₁ generated at a first iteration using a second text string different from the first text string, a label L₂₋₁ can be generated. The synthetic image M₂₋₁ can be applied as a training instance input, to be processed using the anomaly detection ML model, to generate a corresponding output indicating, e.g., a type, a name, and/or a location (which can be highlighted using a bounding box) a corresponding anomaly A₂₋₁. The corresponding output can then be compared with the label L₂₋₁, to determine a further difference, and one or more of the parameters of the anomaly detection ML mode can be adjusted based on the further difference.

In some implementations, the second text string and the first text string can describe different types of anomalies. In some implementations, the second text string and the first text string can describe the same type of anomaly but for different components within the same or different industrial facilities. The anomaly detection ML model can be trained using different synthetic images and corresponding supervised labels until a difference between a model output and a corresponding label is minimized or satisfies a difference threshold.

In various implementations, the method can further include providing the trained anomaly detection ML model for use in anomaly detection within a particular industrial facility.

In various implementations, the method can further include, prior to providing the trained anomaly detection ML model for use in anomaly detection within the particular industrial facility, and for each of multiple real images of the particular industrial facility: processing the real image and a prompt that describes the anomaly, using an image-to-image translation model, to generate a corresponding translated synthetic image; and fine-tuning the trained anomaly detection ML model through further training of the anomaly detection ML model based on the translated synthetic images.

In some implementations, the multiple real images can be captured using one or more vision sensors carried by a mobile robot. The mobile robot can be a quadruped robot (e.g., a robot dog), a wheeled robot, an unmanned aerial vehicle, or any other applicable robot movable within the industrial automation facility. The one or more vision sensors can be a monographic RGB camera, a stereographic camera, a thermal camera, or any other applicable vision sensor. Correspondingly, the real image can be a RGB image, a RGB-D image, a thermal image, or any other applicable image

In some implementations, the method can further include using the trained anomaly detection ML model in processing the real images, where using the trained anomaly detection ML model in processing the real images includes: processing the real image of the real images, using the trained anomaly detection ML model, to generate a model output that indicates whether any anomaly is present in one or more of the components; and causing one or more remediating actions to be performed in response to the model output indicating that an anomaly is present in one or more of the components

In various implementations, the method can further include, prior to providing the trained anomaly detection ML model for use in anomaly detection within the particular industrial facility, and for each of multiple real images of the particular industrial facility: processing the real image and a prompt that describes the anomaly, using an image-to-image translation model, to generate a corresponding translated synthetic image; and validating the trained anomaly detection ML model based on the translated synthetic images. Providing the trained anomaly detection ML model for use in anomaly detection within the particular industrial facility is in response to determining the validating satisfies one or more conditions.

In various implementations, validating the trained anomaly detection ML model based on the translated synthetic images is implemented by determining an accuracy measure of anomaly predictions made based on outputs, from the anomaly detection ML model, based on processing the translated synthetic images. In those implementations, determining the validating satisfies one or more conditions can include determining that the accuracy measure satisfies the threshold accuracy measure.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

In some implementations, a system is provided one or more processors and memory storing instructions that, in response to execution by the one or more processors, cause the one or more processors to: for each of multiple text strings that each describe an anomaly and a corresponding industrial facility setting, perform multiple iterations of processing the text string, using a text-to-image model, to generate a corresponding synthetic image at each of the iterations; train an anomaly detection machine learning (ML) model using the generated synthetic images and corresponding supervised labels for the generated synthetic images; and provide the trained anomaly detection ML model for use in anomaly detection within a particular industrial facility.

In various implementations, the system can further include instructions to, prior to providing the trained anomaly detection ML model for use in anomaly detection within the particular industrial facility and for each of multiple real images of the particular industrial facility: process the real image and a prompt that describes the anomaly, using an image-to-image translation model, to generate a corresponding translated synthetic image; and fine-tune the trained anomaly detection ML model through further training of the anomaly detection ML model based on the translated synthetic images.

In various implementations, the system can further include instructions to, prior to providing the trained anomaly detection ML model for use in anomaly detection within the particular industrial facility and for each of multiple real images of the particular industrial facility: process the real image and a prompt that describes the anomaly, using an image-to-image translation model, to generate a corresponding translated synthetic image; and validate the trained anomaly detection ML model based on the translated synthetic images. In those implementations, providing the trained anomaly detection ML model for use in anomaly detection within the particular industrial facility is in response to determining the validating satisfies one or more conditions. In some implementations, validating the trained anomaly detection ML model based on the translated synthetic images includes: determining an accuracy measure of anomaly predictions made based on outputs, from the anomaly detection ML model, based on processing the translated synthetic images. The one or more conditions can include, for instance, a threshold accuracy measure.

In some implementations, providing the trained anomaly detection ML model for use in anomaly detection within the particular industrial facility includes: causing the trained anomaly detection ML model to be used in processing real images that are captured via a vision sensor that is within or outside the particular industrial facility. In some implementations, the vision sensor can be carried by a mobile robot that moves around the particular industrial facility. In some of those implementations, causing the trained anomaly detection ML model to be used in processing real images can include causing the trained anomaly detection ML model to be downloaded locally to the mobile robot that moves around the particular industrial facility, for monitoring and detection of anomalies. By having the trained anomaly detection ML model locally at the mobile robot, images captured using the vision sensor of the mobile robot can be processed using the trained anomaly detection ML model for prompt anomaly detection and/or notification.

In some implementations, causing the trained anomaly detection ML model to be used in processing real images includes causing the trained anomaly detection ML model to be downloaded to one or more on-site computers (e.g., server(s)) that are located at the industrial facility. In some of those implementations, the images captured by the vision sensor are provided to the one or more on-site computers that are within the particular industrial facility, to be processed using the trained anomaly detection ML model that is downloaded to those servers, for anomaly detection.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A schematically depicts an example environment in which selected aspects of the present disclosure can be implemented, in accordance with various embodiments.

FIG. 1B depicts an example flowchart for performing selected aspects of the present disclosure, in accordance with various embodiments.

FIG. 1C depicts examples of machine learning (ML) models for performing selected aspects of the present disclosure, in accordance with various embodiments.

FIG. 2A schematically depicts an example of an image generated utilizing techniques described herein, in accordance with various embodiments.

FIG. 2B schematically depicts an example of another image generated utilizing techniques described herein, in accordance with various embodiments.

FIG. 2C schematically depicts an example of a further image generated utilizing techniques described herein, in accordance with various embodiments.

FIG. 2D schematically depicts an example of an additional image generated utilizing techniques described herein, in accordance with various embodiments.

FIG. 3 illustrates an example method for performing selected aspects of the present disclosure.

FIG. 4 schematically illustrates an example computer architecture on which selected aspects of the present disclosure can be implemented.

### DETAILED DESCRIPTION

Implementations of the present disclosure utilize one or more image generation models to generate a large quantity of images for training, fine-tuning, and/or validating an anomaly detection ML model that is utilized to detect one or more anomalies in component(s) and/or matter(s) within an industrial environment (e.g., an industrial automation facility). The one or more image generation models can include, for instance, a text-to-image model that can be utilized to process a text prompt and generate a realistic synthetic image that is conditioned on the text prompt.

The text-to-image model, for instance, can be utilized to process a text prompt (sometimes referred to herein as “prompt” or “text string”) indicating or describing an anomaly, and generate a detailed and realistic synthetic image that is conditioned on the text prompt. In some implementations, the same text prompt can be processed multiple times/iterations, using the text-to-image model, to generate multiple different synthetic images each reflecting the anomaly.

In some implementations, the different text prompts can describe different anomalies within or surrounding a particular industrial automation facility or a particular type of industrial automation facility (sometimes referred to herein as “industrial facility”), and correspondingly, the different synthetic images generated using the text-to-image model can capture different anomalies within or surrounding the particular (or the particular type of) industrial automation facility. In some implementations, the different text prompts can describe different anomalies within or surrounding different industrial facilities, and correspondingly, the different synthetic images generated using the text-to-image model can capture different anomalies within or surrounding the different industrial facilities. The different synthetic images generated based on the same text prompt for the multiple iterations and/or the different synthetic images generated based on the different text prompts can be applied to train, to fine-tune, and/or to validate an anomaly detection ML model.

In various implementations, the one or more image generation models can additionally or alternatively include an image-to-image model that can be utilized to process a base image and a text prompt to generate a translated/modified synthetic image that generally conforms to the base image, but that includes modification(s) that are consistent with the text prompt. For instance, an image (e.g., a real-world image, or a realistic synthetic image, that does not reflect anomalies) capturing one or more components of an industrial facility and a text prompt describing/indicating an anomaly present in one or more of the components can be provided to the image-to-image model. In this instance, the image-to-image model is utilized to process the image and the text prompt, to generate a modified image that reflects the anomaly described or indicated in the text prompt, but otherwise generally conforms to the image. For instance, if the image captured a floor without any oil, two tanks, and piping, and the text prompt was “add oil on the ground”, the modified image can likewise include the floor, two tanks, and piping, but will include oil on the floor. Accordingly, a modified image can be generated based on a model output of the image-to-image model after processing a base image and text prompt, where the modified image is a modified version of the real-world image that reflects the anomaly indicated in the text prompt.

In some implementations, using the same image capturing the same component(s) of an industrial facility and different text prompts that describe different anomalies to the component(s), a variety of modified images can be generated using the image-to-image models. Each of the variety of modified images can reflect a corresponding anomaly described or indicated by a respective one of the different text prompts, and the variety of the modified images (or a portion thereof) can be applied as diverse “positive” ground truth images for training, fine-tuning, and/or validation of anomaly detection ML model(s) in detecting anomalies for certain particular components within the industrial facility.

In some implementations, as a working example, different images capturing different components of an industrial facility (or more than one industrial facility) in its normal state (i.e., without anomalies) can be acquired using one or more real vision sensors. The one or more vision sensors, for instance, can be attached to a robot that is located within the industrial facility or that can be positioned at different locations within the industrial facility. The one or more vision sensors can be a monographic RGB camera, a stereographic camera, a thermal camera, and/or any other applicable vision sensor. The robot can be, for instance, a mobile robot such as a robot dog that travels around and through the industrial facility. It is noted that an image captured using a real vision sensor or other real sensor device(s) is often referred to as a “real image”, a “real-life image”, or a “real-world image”, while an image generated using the aforementioned image generation model (e.g., the text-to-image model or image-to-image model) is often referred to as a “synthetic image”.

Continuing with the working example above, different text prompts describing different anomalies can be received, for instance, from user input or from a file of collected text descriptions of anomalies. Each of the different images and a corresponding text prompt can be processed using the image-to-image model, for the image-to-image model to output a modified image reflecting an anomaly described in the corresponding text prompt. In this way, different modified images can be generated describing different anomalies for different components and/or for different industrial facilities.

The different modified images (or a portion thereof) can be applied as diverse “positive” ground truth images for training, fine-tuning, and/or validation of anomaly detection ML model(s) in detecting anomalies for different components within the same or different industrial facilities. Additionally or alternatively, one or more real-world images can be selected from the different images acquired using one or more of the vision sensors, and can each be assigned a supervised label of “no anomaly” (by capturing component(s) in normal state). These one or more real-world images can be applied as “negative” ground truth images for training, fine-tuning, and/or validation of the anomaly detection ML model(s). It is noted that the term “positive” is applied here to indicate presence of anomaly, while the term “negative” is applied here to indicate absence of anomaly. It is also noted that when the different modified images (or a portion thereof) are used to train, fine-tune, and/or validate the same ML model (e.g., an anomaly detection ML model), the different modified images can optionally be divided into different sets (e.g., a first set for training, a second set for fine-tuning, and/or a third set for validating) where no modified image is included in more than one of the different sets.

In some implementations, instead of or in addition to the real-world images captured using sensors, a realistic synthetic image capturing one or more components (within an industrial facility) that display no anomaly can also be processed as input, along with a text prompt describing an anomaly foreseeable in the industrial facility, using the image-to-image model, to generate a modified image, for training, fine-tuning, and/or validation purposes. The realistic synthetic image can be generated, for instance, using a ML model (e.g., the aforementioned text-to-image model) that performs text-to-image translations, based on a text string that simply describe the industrial facility (e.g., “chemical plant”).

By utilizing the one or more image generation models to generate synthetic images reflecting anomalies within one or more industrial facilities (or to modify real-life images that capture the one or more industrial facilities and that are free of anomalies to reflect anomalies, or to modify realistic synthetic images that are free of anomalies), a large quantity of diverse synthetic images each reflecting a corresponding anomaly within the one or more industrial facilities can be generated, without a human creating (and later cleaning up and removing) hazardous anomalies. This can also save labor and time in capturing or waiting to capture image(s) when a particular type of anomaly (e.g., anomaly that cannot be easily spotted) occurs. Moreover, by training an anomaly detection ML model using the diverse and realistic synthetic images, accuracy of the anomaly detection ML model in detecting anomalies can be improved.

Additionally or alternatively, the large quantity of synthetic images (or a portion thereof) can also be applied to fine-tune an anomaly detection ML model so that the fine-tuned anomaly detection ML model can be applied to detect different anomalies for particular component(s) or for a particular industrial facility. Additionally or alternatively, a portion of the large quantity of synthetic images can also be applied to validate an anomaly detection ML model before deployment so that the quality of the anomaly detection ML model in detecting anomalies can be ensured.

In some implementations, given a total of N (where N is >1) different synthetic images generated using a text-to-image model and/or an image-to-image model, a first set of the different synthetic images can be applied to initially train an anomaly detection ML model, in order for the first anomaly detection ML model to be trained for utilization in anomaly detection within or surrounding industrial facilities. Also, for example, a second set of the different synthetic images can additionally or alternatively be applied to fine-tune the trained anomaly detection ML model in enhancing anomaly detection for certain types of anomalies, for a particular industrial setting, and/or for a certain type of industrial setting. Also, for example, a third set of the different synthetic images can additionally or alternatively be applied to validate a trained, and optionally fine-tuned, anomaly detection ML model prior to the trained anomaly detection ML model being deployed for detecting anomalies within a particular industrial setting.

As described herein, in various implementations the synthetic images of second set and/or the third set can include (e.g., be restricted to) modified synthetic images that are generated using an image-to-image translation model and based on corresponding real images of the particular industrial setting. For example, synthetic images of the second set can include those generated based on processing, using an image-to-image translation model, a corresponding real image of the particular industrial setting and a corresponding text prompt. In these and other manners the fine-tuning and/or the validating can be specific to the particular industrial setting. Fine-tuning an anomaly detection ML model based on such images can improve accuracy and/or robustness of the anomaly detection ML model for the particular industrial setting. Validating the anomaly detection ML model based on such images can ensure that it will be effective for the particular industrial setting.

Accordingly, implementations described herein relate to training, fine-tuning, and/or validating an anomaly detection machine learning (ML) model to monitor and detect anomalies for one or more components (e.g., a liquid tank) within an industrial facility (e.g., an industrial automation facility), based on text prompts and/or based on images (realistic synthetic images and/or real-world images captured using one or more vision sensors such as cameras) that capture one or more of the components (or a portion thereof).

In various implementations, the anomaly detection ML model can be trained, fine-tuned, and/or validated using a plurality of synthetic images respectively reflecting an anomaly present in one or more of the components. For example, the plurality of synthetic images can include a first set of synthetic images generated based on one or more text strings that respectively describe an anomaly and an industrial facility setting within which the anomaly presents, using a text-to-image ML model (sometimes referred to as “text-to-image model”). Alternatively or additionally, the plurality of synthetic images can include a second set of synthetic images generated based on real-world images that are each conditioned on a text string (e.g., introducing/adding an anomaly in a respective image of the real-world images), using an image-to-image ML model (sometimes referred to as “image-to-image model”).

It is noted that, in some implementations, an image generation model can serve both as the text-to-image model and the image-to-image model. In other words, the image generation model can perform both text-to-image translations and image-to-image translations. The real-world images, for instance, can be captured using one or more vision sensors carried by a mobile robot (e.g., a robot dog). By training, fine-tuning, or validating the anomaly detection ML model using a wide range of (or selected) synthetic images (e.g., realistic synthetic images) that are generated by the text-to-image model and/or the image-to-image model and that respectively reflect a corresponding anomaly within the industrial facility setting, there is no need to wait for and spot occurrence of anomalies (e.g., corrosion of pipes or other components) which take a while. Nor is there a need to force occurrence of anomalies that are hazardous, e.g., oil spill or other liquid on the ground of the industrial facility setting. Moreover, costs and labor associated with capturing appropriate images of the occurrence of anomalies can also be saved or reduced.

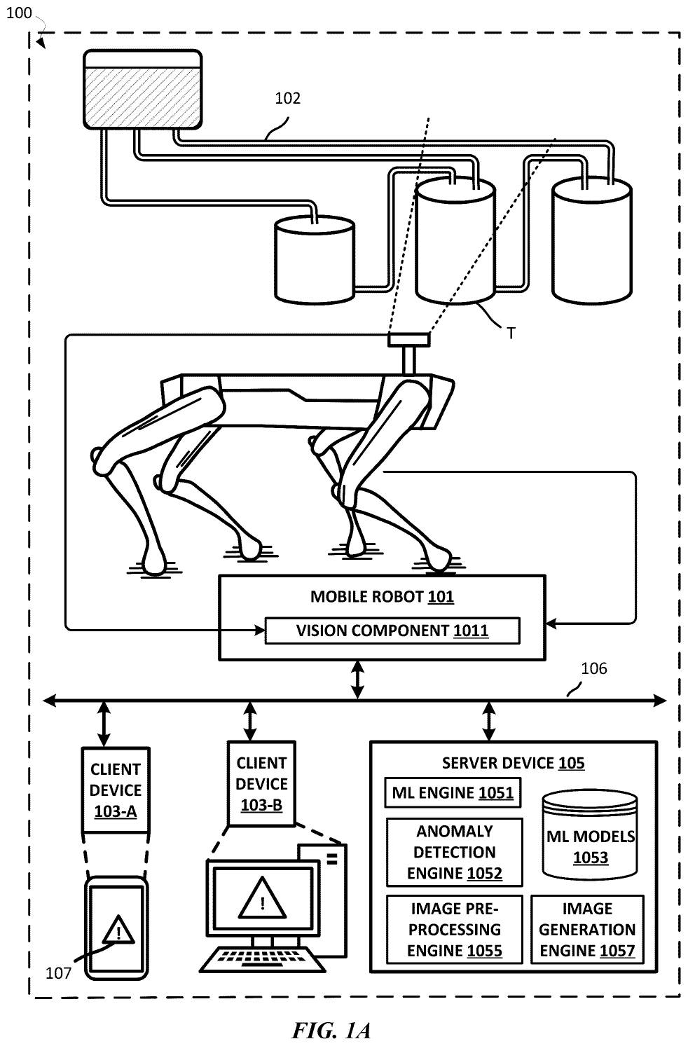

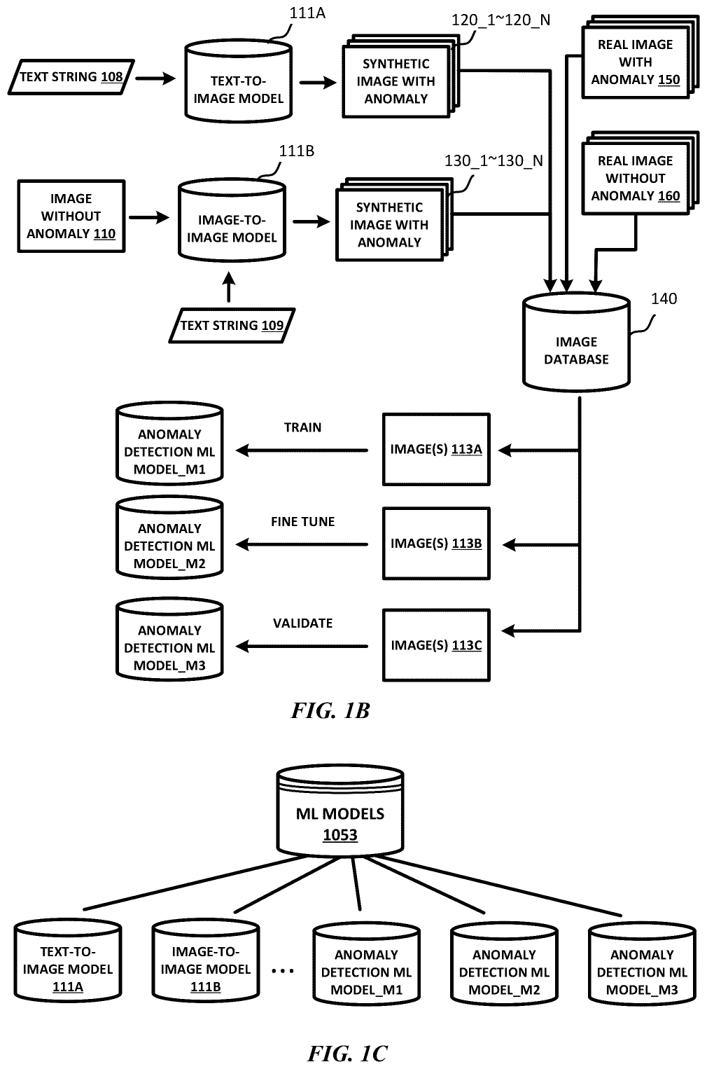

Turning now to the Figures, FIG. 1A schematically depicts an example environment in which selected aspects of the present disclosure can be implemented, in accordance with various embodiments. FIG. 1B depicts an example flowchart for performing selected aspects of the present disclosure, in accordance with various embodiments. FIG. 1C depicts examples of machine learning (ML) models for performing selected aspects of the present disclosure, in accordance with various embodiments. Referring now to FIG. 1A, an example environment 100 in which various aspects of the present disclosure can be implemented is depicted schematically. The example environment 100 can be, or can include, an industrial automation facility, which can take numerous forms. For instance, the example environment 100 can be designed to implement any number of at least partially automated processes. The industrial automation facility can take the form of a chemical processing plant, an oil or natural gas refinery, a catalyst factory, a manufacturing facility, an offshore oil platform, etc.

The example environment 100 can include one or more client devices (e.g., local client devices 103-A and 103-B) operably coupled with a process automation network 106 in the industrial automation facility. The client device 103-A or 103-B can be implemented as a computer (e.g., laptop, desktop, notebook), a tablet, a robot, a smart appliance (e.g., smart phone), a messaging device, a wearable device (e.g., watch), or any other applicable device. The process automation network 106 can be implemented using various wired and/or wireless communication technologies, including but not limited to the Institute of Electrical and Electronics Engineers (IEEE) 802.3 standard (Ethernet), IEEE 802.11 (Wi-Fi), cellular networks such as 3GPP Long Term Evolution (“LTE”) or other wireless protocols that are designated as 3G, 4G, 5G, and beyond, and/or other types of communication networks of various types of topologies (e.g., mesh).

The example environment 100 can further include a mobile robot 101 having or carrying a vision component 1011. The mobile robot 101 can be a quadruped robot (e.g., a robot dog), a wheeled robot, an unmanned aerial vehicle, or any other applicable robot movable within the industrial facility. The vision component 1011 can be a monographic camera, a stereographic camera, a thermal camera, or any other applicable vision sensor, to capture one or more images of one or more particular components (e.g., a liquid tank T or tube 102 storing or transporting a liquid matter) of the industrial automation facility. The vision component 1011 can be removably coupled to, or be integrated into, the mobile robot 101. In some implementations, the vision component 1011 can change location and/or orientation with respect to the mobile robot 101, for example, by rotation or other movement. The mobile robot 101 can, in addition to the vision component 1011, include one or more additional vision components to navigate through the industrial facility, sense static or dynamic objects, and/or to capture images.

The example environment 100 can further include a server computing device 105 (can be simply referred to as “server device”). The server computing device 105 can include a machine learning (ML) engine 1051, an anomaly detection engine 1052, and an image generation engine 1057. The server computing device 105 can further include, or otherwise access, one or more machine learning (ML) models 1053. The one or more ML models 1053 can include an anomaly detection ML model (e.g., M1, M2, and/or M3 in FIG. 1B).

Alternatively or additionally, the one or more ML models 1053 can include an image generation model (e.g., text-to-image model 111A or image-to-image model 111B in FIG. 1B) that performs text-to-image translation and/or image-to-image translation. In some implementations, the one or more ML models 1053 can include a first model for anomaly detection for a first site and a second model for anomaly detection at a second site, where the first site is different from the second site.

The server computing device 105 can be connected to a plurality of client devices. The server computing device 105 can be in communication with one or more local client devices (e.g., 103-A and 103-B), and/or be in communication with one or more remote client devices (not illustrated). The local client device 103-A or 103-B can be connected to the server computing device 105 via one or more local area networks (e.g., the process automation network 106), and the remote client device can be connected to the server computing device 105 via one or more wide area networks (e.g., the Internet). The local client device(s) and the remote client device(s) can be operable by personnel such as system integrators to configure and/or interact with various aspects of the example environment 100.

In some implementations, the server computing device 105 may, in addition to the ML engine 1051 and the anomaly detection engine 1052, include a database (not illustrated) that stores information used by the ML engine 1051 and/or the anomaly detection engine 1052 and/or the image generation model 1057 to practice selected aspects of the present disclosure. In some implementations, the server computing device 105 may, in addition to the ML engine 1051 and the anomaly detection engine 105, include an image pre-processing engine 1055 that, for instance, processes different images (e.g., images captured using different vision sensors) to have the same image dimension. Various aspects of the server computing device 105, such as the ML engine 1051, the anomaly detection engine 1052, the image generation engine 1057, and/or the image pre-processing engine 1055, can be implemented using any combination of hardware and software.

In some implementations, the ML engine 1051, the anomaly detection engine 1052, the image pre-processing engine 1055, or the trained ML model 1053 can be implemented across multiple computer systems as part of what is often referred to as a “cloud infrastructure” or simply the “cloud.” However, this is not required, and in FIG. 1A, for instance, the ML engine 1051 is implemented within the industrial facility, e.g., in a single building or across a single campus of buildings or other industrial infrastructure. In such an implementation, the ML engine 1051 can be implemented on one or more local computing systems, such as on one or more server computers.

In some implementations, the mobile robot 101 can navigate through the industrial facility and capture images at one or more spots (e.g., designated spots). For example, as shown in FIG. 1A, the vision component 1011 of the mobile robot 101 can be (but not necessarily need to be) configured at a given pose, to capture an image of the liquid tube 102 at the given pose. In some implementations, the image captured by the vision component 1011 can be processed as input, using the anomaly detection model (after being trained and/or validated), to generate a model output indicating whether an anomaly is present in component(s) captured in the image.

For instance, the model output can include a classification result predicting a probability for each of a predetermined number of anomalies to exist within the image. As a non-limiting example, the classification result, for instance, can be: (oil spill, 0.7), (no oil spill, 0.3). In this non-limiting example, it can be determined that an anomaly corresponding to “oil spill” is detected from the image with a confidence score of approximately “0.7” (which satisfies a predefined confidence score threshold, e.g., 0.6). In response to detecting the anomaly “oil spill”, one or more mitigation/remediating actions can be performed, including but are not limited to: generating a warning message (e.g., 107 in FIG. 1A, as rendered via the client device 103-A) or issuing a warning sound, to notify responsible staff of the oil spill.

As another non-limiting example, the classification result, for instance, can be: (oil spill, 0.1); (corrosion, 0.8); (fire, 0.1). In this non-limiting example, it can be determined that an anomaly corresponding to “corrosion” is detected from the image with a confidence score of approximately “0.8” (which satisfies a predefined confidence score threshold, e.g., 0.6). In response to detecting the anomaly “oil spill”, one or more mitigation/remediating actions can be performed, including but are not limited to: generating a warning message or issuing a warning sound, to notify responsible staff of the corrosion.

In some implementations, the image captured by the vision component 1011 can be processed as input along with a text prompt (or text string) that introduces an anomaly into the image, using the image-to-image model, to generate a modified image that reflects the anomaly which is described or indicated in the text prompt. As a non-limiting example, the image captured by the vision component 1011 can be a real-world image capturing one or more oil tanks within a storage room of an industrial facility. Such real-world image, along with a text prompt (e.g., “add oil spill on the ground”), can be provided to the aforementioned image generation model, to perform an image-to-image translation that is conditioned on the text prompt, where an output of the image generation model (e.g., image-to-image model) corresponds to a modified image (which is a realistic synthetic image) that modifies the real-world image to show oil spill on the ground of the storage room where the one or more oil tanks stand.

In the above non-limiting example, a supervised label can be generated based on the modified image and/or based on the text prompt (e.g., “add oil spill on the ground”). A human operator trained on recognizing anomalies in the industrial facility setting can scan the modified image to determine a supervised label (e.g., “oil” spill) for the anomaly. Alternatively, the supervised label (e.g., “oil spill”) can be extracted from the text prompt (e.g., “add oil spill on the ground”) automatically and/or can be verified by the human operator by examining the modified image. The modified image and the supervised label can then be applied to generate a training instance (here, a “positive” training instance as an anomaly is present), or an instance for fine-tuning or validation.

For example, the modified image (e.g., a realistic synthetic image showing oil spill on the ground of a storage room where one or more oil tanks are stored) can be applied and saved as a training instance input (“positive” ground truth image) of the training instance, and the supervised label can be applied and saved as a ground truth label for the training instance. The training instance can be applied to train an anomaly detection ML model, where the modified image can be processed using the anomaly detection ML model, to generate a model output (e.g., indicating whether an anomaly of “oil spill” is detected within the modified image and/or a confidence score that the anomaly of “oil spill” is detected within the modified image). The model output can be compared with the ground truth label of “oil spill”, based on which, one or more weights/parameters of the anomaly detection ML model can be fitted (or fine-tuned in case the modified image and the ground truth label are saved as for purpose of fine-tuning a model).

Additionally or alternatively, the aforementioned real-world image capturing one or more oil tanks within the storage room of the industrial facility can be assigned a supervised label of “no anomaly”. The real-world image capturing one or more oil tanks within the storage room of the industrial facility and the supervised label of “no anomaly” can be saved as a “negative” training instance to train the anomaly detection ML model. Additionally or alternatively, the real-world image capturing one or more oil tanks within the storage room of the industrial facility and the supervised label of “no anomaly” can be applied to generate an instance for fine-tuning and/or validating an additional anomaly detection ML model that is different from the anomaly detection ML model.

Optionally, more than one real-world image can be captured using the vision component 1011 (and/or using additional sensors). As a non-limiting example, a total number of 1,000 real-world images can be captured using the vision component 1011. The total number of 1,000 real-world images (or a portion thereof) can each be conditioned on a first text prompt describing a first anomaly within a first type of facility and be processed using the image generation model (the image-to-image model 111B) for 100 iterations, to generate 100,000 synthetic images reflecting the first anomaly within the first type of facility. The total number of 1,000 real-world images (or a portion thereof) can each be conditioned on a second text prompt describing a second anomaly within the first type of facility (or a second type of facility different from the first type) and be processed using the image generation model (the image-to-image model 111B) for 50 iterations, to generate 50,000 additional synthetic images reflecting the second anomaly within the first (or second) type of facility. Further synthetic images can be generated similarly, and repeated descriptions are omitted herein.

It is noted that the number of iterations performed for each text prompt can depend on a type of the anomaly described or indicated in a corresponding text prompt and/or can depend on function/usage of the anomaly detection ML model to be trained (or fine-tuned, or validated). In some implementations, the number of iterations performed for a particular text prompt can be increased by identifying that an anomaly described by the particular text prompt is of particular interest to train, to fine-tune, or to validate the anomaly detection ML model.

Continuing with the non-limiting example above, in some implementations, the 100,000 synthetic images reflecting the first anomaly within the first type of facility can be assigned a first supervised label identifying the first anomaly (e.g., type, name, location, etc.), and the 50,000 additional synthetic images reflecting the second anomaly within the first (or second) type of facility can be assigned a second supervised label identifying the second anomaly (e.g., type, name, location, etc.). The 100,000 synthetic images and the 50,000 additional synthetic images can be divided into three groups each for purposes of training, fine-tuning, and validating.

For instance, the 100,000 synthetic images and the 50,000 additional synthetic images can be divided into: a first training group of synthetic images that contain 80,000 out of the 100,000 synthetic images and 40,000 out of the 50,000 additional synthetic images; a second fine-tuning group of synthetic images that contain 15,000 out of the 100,000 synthetic images and 8,000 out of the 50,000 additional synthetic images; and a third validating group of synthetic images that contain 5,000 out of the 100,000 synthetic images and 2,000 out of the 50,000 additional synthetic images. For instance, the first training group of synthetic images can be applied to generating “positive” training instances to train an anomaly detection model, the second fine-tuning group of synthetic images can be applied to generating “positive” instances to fine-tune the same anomaly detection model, and the third validating group of synthetic images can be applied to generating “positive” instances to validate the same anomaly detection model.

It is noted that if training and fine-tuning (or validation) are applied to different anomaly detection models, the 100,000 synthetic images (or a portion thereof) and the 50,000 additional synthetic images (or a portion thereof) can be applied to train a first anomaly detection model, and the same 100,000 synthetic images (or a portion thereof) and the same 50,000 additional synthetic images can be applied to fine-tune a second anomaly detection model that is different or separate from the first anomaly detection model.

Continuing with the non-limiting example above, the aforementioned total number of 1,000 real-world images (and/or additional real-world images) can each be assigned a supervised label of “no anomaly”. The 1,000 real-world images (and/or additional real-world images), for instance, can be divided into: a first training group of real-world images containing 7,500 real-world images, a second fine-tuning group of real-world images containing 2,000 real-world images, and a third training group of real-world images containing 500 real-world images. The first training group can be applied to generate “negative” training instances to train an anomaly detection model, the second fine-tuning group of real-world images can be applied to generate “negative” fine-tuning instances to fine-tune the same anomaly detection model, and the third validating group of real-world images can be applied to generate “negative” validating instances to validate the same anomaly detection model. It is noted that if training and fine-tuning (or validation) are applied to different anomaly detection models, an image from the 1,000 real-world images (and/or additional real-world images) can be applied to train (fine-tune, or validate) a first model while also being applied to train (fine-tune, or validate) a second model different from the

Referring now to FIG. 1C, the ML models 1053 stored in a ML model database can include a text-to-image model 111A that performs text-to-image translations, an image-to-image model 111B that performs image-to-image translations, an anomaly detection ML model M1 for detecting a first particular type of anomaly, an anomaly detection ML model M2 for detecting a second particular type of anomaly different from the first particular type, and/or an anomaly detection ML model M3 that is capable of detecting a predefined number of anomalies (e.g., including the first and second particular types of anomalies), and/or other ML models. In some implementations, instead of storing the text-to-image model 111A and the image-to-image model 111B that is separate or independent of the text-to-image model 111A, the ML model database can include or otherwise access an image generation model that performs both text-to-image translations and image-to-image translations. It is noted that the image-to-image translations can be conditioned on a text prompt that describes a corresponding anomaly specific to an industrial facility. The anomaly described in the text prompt can vary depending on the type and location (or other factors) of the facility. Moreover, different text prompts can describe different anomalies.

Referring now to FIG. 1B, a text string 108 (sometimes referred to as “prompt” or “text prompt”) can be provided to the text-to-image model 111A. The text string 108 can be, for instance, “interior of a chemical plant with oil on the floor”. The text string 108 can be processed using the text-to-image model 111A multiple times/iterations. For instance, at a first iteration, the text string 108 can be processed as a single input, using the text-to-image model 111A, to generate an image 120_1 showing a first chemical plant with oil on a floor of the first chemical plant. At a second iteration, the text string 108 can be processed as a single input, using the text-to-image model 111A, to generate an additional image 120_2 showing a second chemical plant with oil on a floor. The second chemical plant can be the same as or different from the first chemical plant. Alternatively, the oil on the floor of the first chemical plant can have a different size, location, or color (or other features) than that of the second chemical plant. Similarly, at a Nth iteration, the text string 108 can be processed as a single input, using the text-to-image model 111A, to generate an image 120_N showing a Nth chemical plant with oil on the floor. Optionally, the images 120_1, 120_2, . . . , 120_N can be stored in an image database 140. The images 120_1, 120_2, . . . , 120_N can be examined (e.g., by technicians, human operators, etc.) to determine corresponding supervised labels (e.g., “oil on the ground”, “oil spill”, “oil spill on the left”, etc.). Alternatively, the supervised labels (e.g., “oil on the ground”) can be determined or extracted from the text string 108 (e.g., “interior of a chemical plant with oil on the floor”), and/or can be verified by human operators.

Once a supervised label is determined for each of the images 120_1˜120_N, a plurality of training instances can be generated. For instance, a first training instance can be generated to include the image 120_1 as first training instance input, and to include a first supervised label (e.g., “oil spill”) as a ground truth label for comparison with model output of an anomaly detection ML model (e.g., M1 in FIG. 1A) that processes as input the first training instance. Similarly, a second training instance can be generated to include the image 120_2 as second training instance input, and to include a second supervised label (e.g., “oil spill”) as a ground truth label for comparison with model output of the anomaly detection ML model (e.g., M1 in FIG. 1A) that processes as input the second training instance. . . . A Nth training instance can be generated to include the image 120_N as an Nth training instance input, and to include a Nth supervised label (e.g., “oil spill”) as a ground truth label for comparison with model output of the anomaly detection ML model (e.g., M1 in FIG. 1A) that processes as input the Nth training instance. Based on the comparison(s), one or more weights/parameters of the anomaly detection ML model M1 can be fitted/modified/updated.

In some implementations, instead of or in addition to being applied to generate training instances, the images 120_1˜120_N (or a portion thereof) and their corresponding supervised labels can be applied to generate one or more fine-tuning instances. The generated one or more fine-tuning instances (if do not containing images that have been used to train the model M1) can be applied to fine-tune the model M1, i.e., one or more of the weights/parameters of one or more layers of the anomaly detection ML model M1 can be fine-tuned or adjusted. The generated one or more fine-tuning instances (if containing images that have been used to train the model M1) can be applied to fine-tune a trained anomaly detection ML model (e.g., M2 in FIG. 1B) that is different from the anomaly detection ML model M1. For example, the image 120_1 can be selected as a first fine-tuning instance input for a first fine-tuning instance and a supervised label corresponding to the image 120_1 can be selected as a first ground truth label for the first fine-tuning instance. The image 120_1 can be processed using the trained anomaly detection ML model, to generate a model output indicating, for instance, a name and location of the anomaly. The model output can be compared with the supervised label that corresponds to the image 120_1 to determine a difference, based on which, one or more weights of the trained anomaly detection ML model is fine-tuned.

In some implementations, instead of or in addition to being applied to generate training instances, the images 120_1˜120_N (or a portion thereof) and their corresponding supervised labels can be applied to generate one or more validating instances (sometimes also referred to as “testing instances”). For example, the image 120_1 can be selected as a first validating instance input for a first validating instance and a supervised label corresponding to the image 120_1 can be selected as a first ground truth label for the first validating instance. The first validating instance can be applied to validate an anomaly detection ML model (e.g., M3 in FIG. 1B) by determining whether a difference between the first ground truth label and a model output of the anomaly detection ML model that corresponds to the image 120_1 satisfies a difference threshold. In case the image 120_1˜120_N (or a portion thereof) and their corresponding supervised labels can be applied to generate testing instance(s), performance of an anomaly detection ML model (e.g., M3 in FIG. 1B) can be evaluated, for instance, based on whether output of the model M3 satisfies one or more conditions (e.g., an accuracy measure described in other aspects of this disclosure).

In some implementations, still referring to FIG. 1B, an image 110 capturing a component of an industrial facility that is in a normal status (e.g., without anomaly) can be captured using a vision sensor (therefore the image 110 is a real-life image). The image 110 can be provided to an image-to-image model 111B, along with a text string 109 (e.g., “add an oil puddle”) that introduces an anomaly of “oil puddle” to the industrial facility. The image 110 and the text string 109 (e.g., “add an oil puddle”) can be processed as input using the image-to-image model 111B, to generate a modified image (e.g., 130_1, which is realistic and synthetic) that modifies the real-life image 110 to show an oil puddle with respect to the component of the industrial facility.

In some implementations, the image 110 and the text string 109 (e.g., “add an oil puddle”, or “add an oil puddle near oil tank”) can be processed as input using the image-to-image model 111B for multiple times/iterations, where at a first iteration, the modified image 130_1 is generated by the image-to-image model 111B based on the image 110 which is conditioned on the text string 109, a modified image 130_2 is generated at a second iteration by the image-to-image model 111B based on the image 110 which is conditioned on the text string 109, and a modified image 130_N is generated at an Nth iteration by the image-to-image model 111B based on the image 110 which is conditioned on the text string 109. The modified images 130_1, 130_2, . . . , 130_N (or a portion thereof), along with a supervised label (e.g., extracted or determined from the text string 109) can be respectively applied to train, fine-tune, and/or validate one or more anomaly detection ML models.

Additionally or alternatively, a text string (e.g., “add corrosion to oil tank”) different from the text string 109 can be provided to the image-to-image model 111B, along with the image 110. Such text string and the image 110 can be processed using the image-to-image model 111B for multiple iterations, to generate a plurality of modified images. Similarly, a supervised label can be created and verified for each of the plurality of modified images, where such supervised label can be determined, for instance, from the text string of (e.g., “add corrosion to the oil tank”, or “add corrosion to the left tank”).

It is noted that in some implementations, the image 110 does not need to be a real image. For instance, the image 110 can be a realistic synthetic image which is generated, e.g., the text-to-image model 111A based on a text string describing an industrial facility setting. In these implementations, the text string processed by the text-to-image model 111A describes no anomaly, and as a result, the generated realistic synthetic image shows or reflects no anomaly but the industrial facility setting.

In some implementations, additionally or alternatively, the image database 140 can further store one or more real images 150 captured using physical sensors and each reflecting a corresponding anomaly. In some implementations, additionally or alternatively, the image database 140 can further store one or more real images 160 captured using physical sensors and each reflecting no anomaly. The one or more real images 150 can be stored in the image database 140 in association with a corresponding supervised label identifying or indicating a corresponding anomaly. The one or more real images 160 can each be stored in the image database 140 in association with a supervised label, e.g., “no anomaly”. The one or more real images 150 (or a selected portion thereof) and corresponding supervised label(s) can be applied as “positive” ML instances to train, fine-tune, and/or validate anomaly detection models such as the model M1 (or other anomaly detection ML models such as M2 or M3) for anomaly detection. The one or more real images 150 (or a selected portion thereof) and corresponding supervised label(s) can be applied as “negative” training instances to train, fine-tune, and/or validate anomaly detection models such as the model M1 (or other anomaly detection ML models such as M2 or M3) for anomaly detection.

In some implementations, one or more images 113A can be selected from the image database 140 to train an anomaly detection ML model (e.g., M1), where the one or more images 113A can include, image(s) from the synthetic images (e.g., images 120_1˜120_N) generated using the text-to-image model 111A, image(s) from the synthetic images (e.g., images 130_1˜130_N) generated using the image-to-image model 111B, image(s) from the real images 150 capturing anomalies, image(s) from the real images 160 not capturing anomalies, and/or other applicable images. For instance, the image database 140 may also include a synthetic image showing an anomaly, where such synthetic image without anomaly is generated using the image-to-image model 111B based on an initial synthetic image (without anomaly) which is generated using the text-to-image model 111A (that receives a text input simply describing a scenario or industrial facility). Image(s) included in the image database 140 are not limited to descriptions herein.

In some implementations, one or more images 113B can be selected from the image database 140 to fine-tune an anomaly detection ML model (e.g., M2), where the one or more images 113B can include, image(s) from the synthetic images (e.g., images 120_1˜120_N) generated using the text-to-image model 111A, image(s) from the synthetic images (e.g., images 130_1˜130_N) generated using the image-to-image model 111B, image(s) from the real images 150 capturing anomalies, image(s) from the real images not capturing anomalies, and/or other applicable images (e.g., as described above).

In some implementations, one or more images 113C can be selected from the image database 140 to validate an anomaly detection ML model (e.g., M3), where the one or more images 113C can include, image(s) from the synthetic images (e.g., images 120_1˜120_N) generated using the text-to-image model 111A, image(s) from the synthetic images (e.g., images 130_1˜130_N) generated using the image-to-image model 111B, image(s) from the real images 150 capturing anomalies, image(s) from the real images not capturing anomalies, and/or other applicable images (e.g., as described above).

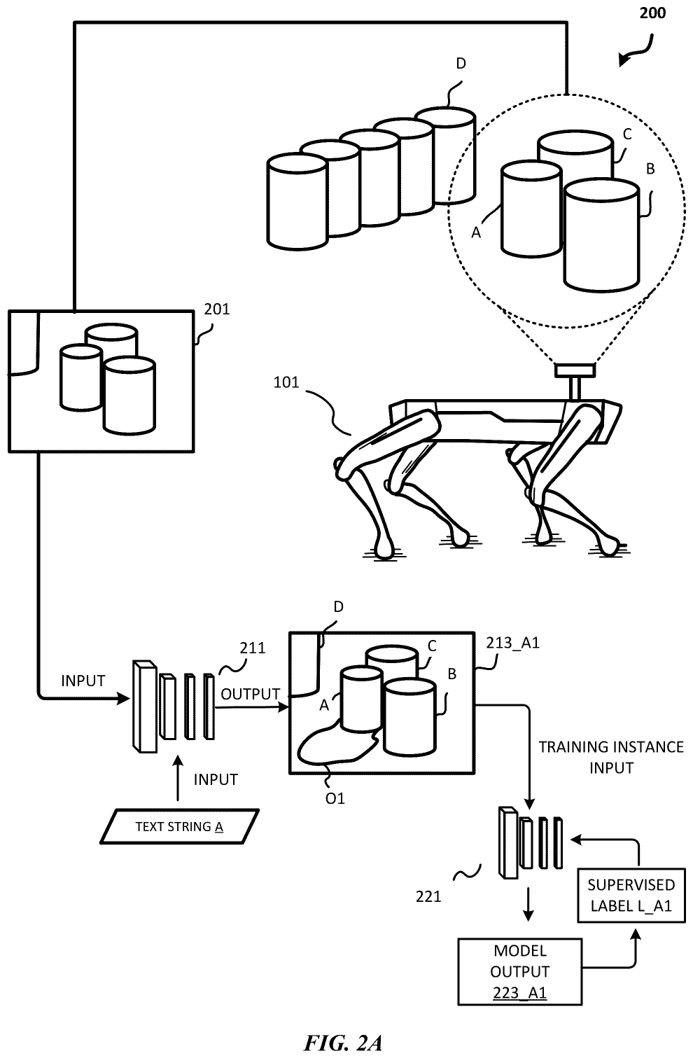

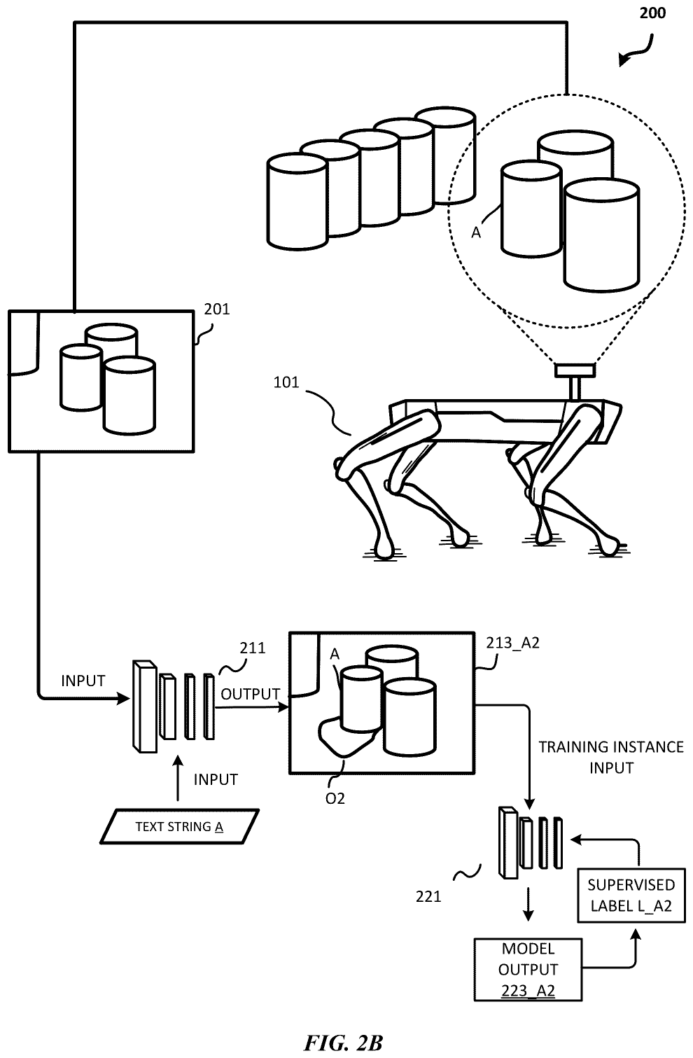

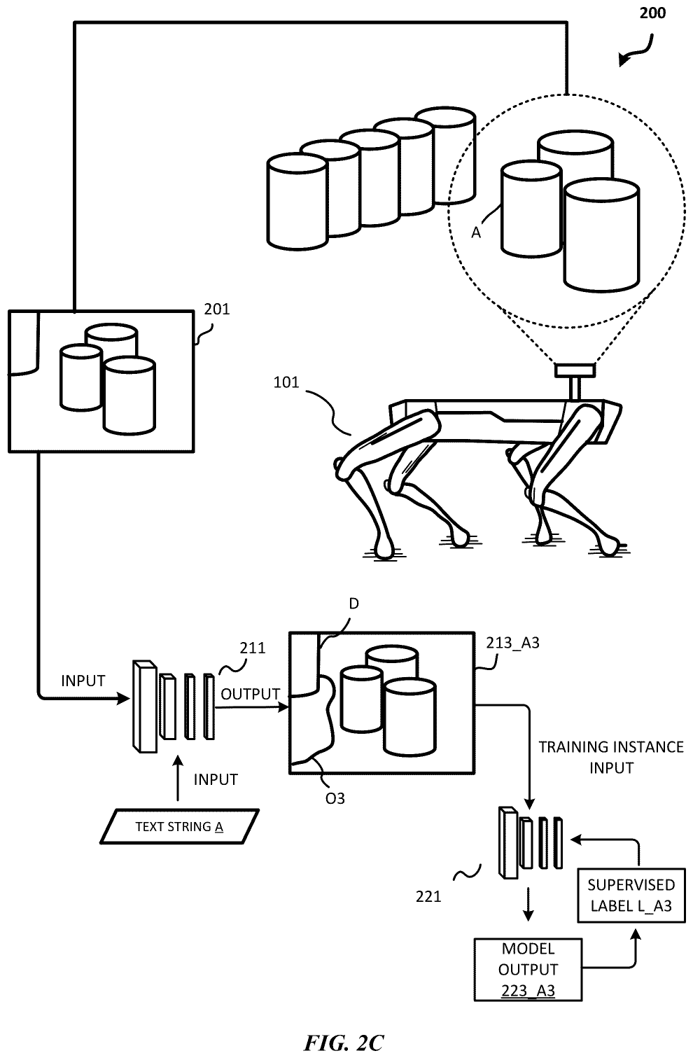

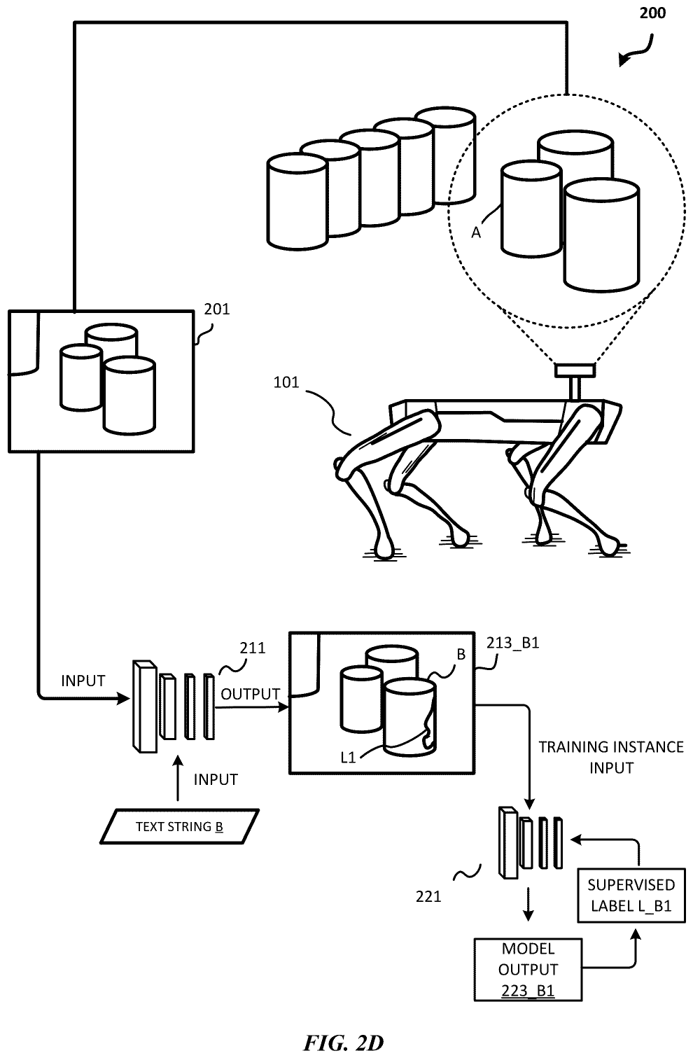

FIG. 2A schematically depicts an example of an image generated utilizing techniques described herein, in accordance with various embodiments. FIG. 2B schematically depicts an example of another image generated utilizing techniques described herein, in accordance with various embodiments. FIG. 2C schematically depicts an example of a further image generated utilizing techniques described herein, in accordance with various embodiments. Referring now to FIG. 2A, a mobile robot 101 carrying a vision sensor is used to capture images of an industrial facility 200 during a period of time (e.g., weeks, months or even longer). From the images captured during the period of time, a set of images each capturing an anomaly within the industrial facilities are selected and labeled, where the set of labeled images are applied to train an anomaly detection ML model 221. An additional set of images not capturing any anomaly can be selected from the images captured during the period of time. The additional set of images, for instance, can include an image 201 (which is a real-world image) capturing a plurality of oil tanks (e.g., tank A, tank B, tank C, and a portion of tank D, as seen in a region of the industrial facility 200 as circled by dashed line). The image 201 can be processed as input, along with a text string A (e.g., “add an oil puddle on ground”), using an image-to-image model 211, for one or more times/iterations.

For instance, as shown in FIG. 2A, at a first iteration, a realistic synthetic image 213 A1 can be derived from a model output of the image-to-image model 211 that corresponds to the image 201 and the text string A. The realistic synthetic image 213_A1 can be a modified version of the real-world image 201 by adding an oil puddle “O1” on the ground next to tank A. A supervised label L_A1 (e.g., “oil spill” or “oil puddle”) can be determined for the realistic synthetic image 213_A1, and a training instance A1 can be generated to include the realistic synthetic image 213_A1 as a training instance input and the supervised label L_A1 as a ground truth label. The anomaly detection ML model 221 can be trained (or otherwise validated or fine-tuned if having been trained) using the training instance A1. For example, the realistic synthetic image 213_A1 can be processed as input using the anomaly detection ML model 221, to generate a model output 223_A1 for comparison with the supervised label L_A1 to determine a difference between the model output 223_A1 and the supervised label L_A1. Based on the difference, one or more weights/parameters of the anomaly detection ML model 221 can be fitted (or fine-tuned).

At a second iteration, referring to FIG. 2B, the same image 201 and the same text string A can be processed as input, using the image-to-image model 211, to generate a model output from which a realistic synthetic image 213_A2 can be generated/derived. The realistic synthetic image 213_A2 can be a modified version of the real-world image 201 by adding an oil puddle “O2” on the ground next to tank A. The oil puddle “O2” in the realistic synthetic image 213 A2 can have a different size, shape, and/or location compared to the oil puddle “O1” in the realistic synthetic image 213_A1. A supervised label L_A2 (e.g., “oil spill” or “oil puddle”) can be determined for the realistic synthetic image 213_A2, and a training instance A2 can be generated to include the realistic synthetic image 213_A2 as a training instance input and the supervised label L_A2 as a ground truth label. The anomaly detection ML model 221 can be trained (or validated or fine-tuned) using the training instance A2. For example, the realistic synthetic image 213_A2 can be processed as input using the anomaly detection ML model 221, to generate a model output 223_A2 for comparison with the supervised label L_A2 to determine a difference between the model output 223_A2 and the supervised label L_A2. Based on the difference, one or more weights/parameters of the anomaly detection ML model 221 can be modified/fitted (or fine-tuned).

At a third iteration, referring to FIG. 2C, the same image 201 and the same text string A can be processed as input, using the image-to-image model 211, to generate a model output from which a realistic synthetic image 213_A3 can be generated/derived. The realistic synthetic image 213_A3 can be a modified version of the real-world image 201 by adding an oil puddle “O3” on the ground next to tank D. The oil puddle “O3” in the realistic synthetic image 213_A3 can have a different size, shape, and/or location compared to the oil puddle “O1” in the realistic synthetic image 213_A1 (and/or the oil puddle “O2” in the realistic synthetic image 213_A2). A supervised label L_A3 (e.g., “oil spill” or “oil puddle”) can be determined for the realistic synthetic image 213_A3, and a training instance A3 can be generated to include the realistic synthetic image 213_A3 as a training instance input and the supervised label L_A3 as a ground truth label. The anomaly detection ML model 221 can be trained (or validated or fine-tuned) using the training instance A3. For example, the realistic synthetic image 213_A3 can be processed as input using the anomaly detection ML model 221, to generate a model output 223_A3 for comparison with the supervised label L_A3 to determine a difference between the model output 223_A3 and the supervised label L_A3. Based on the difference, one or more weights/parameters of the anomaly detection ML model 221 can be fitted (or fine-tuned in case fine tuning is performed). It is noted that more realistic synthetic images can be generated if additional iterations are performed, and repeated descriptions are omitted herein.

In some implementations, the anomaly detection ML model 221 can be a ML model to be trained (or to be validated, or to be fine-tuned) based on real-world image(s) (if there is any capturing anomaly) and/or realistic synthetic image(s) (e.g., the image 201) generated/derived from the processing of real-world image(s) (that do not capture any anomaly) that is conditioned on a text string describing an anomaly in an industrial facility. For instance, referring to FIG. 2D, the image 201 (e.g., a real-world image) can be processed as input, along with a text string B (e.g., “add leakage”), using the image-to-image model 211, to generate a model output from which a realistic synthetic image 213_B1 can be generated/derived. The realistic synthetic image 213_B1 can be a modified version of the real-world image 201 by adding oil leakage (denoted by “L1” in FIG. 2D) for tank B (or other tank(s)).

A supervised label L_B1 (e.g., “oil leakage”) can be determined for the realistic synthetic image 213_B1, and a training instance B1 can be generated to include the realistic synthetic image 213_B1 as a training instance input and the supervised label L_B1 as a ground truth label. The anomaly detection ML model 221 can be trained using the training instance B1. For example, the realistic synthetic image 213_B1 can be processed as input using the anomaly detection ML model 221, to generate a model output 223_B1 for comparison with the supervised label L_B1, thereby determining a difference between the model output 223_B1 and the supervised label L_B1. Based on the difference, one or more weights/parameters of the anomaly detection ML model 221 can be modified/fitted. It is noted that more realistic synthetic images can be generated if additional iterations are performed, and repeated descriptions are omitted herein.

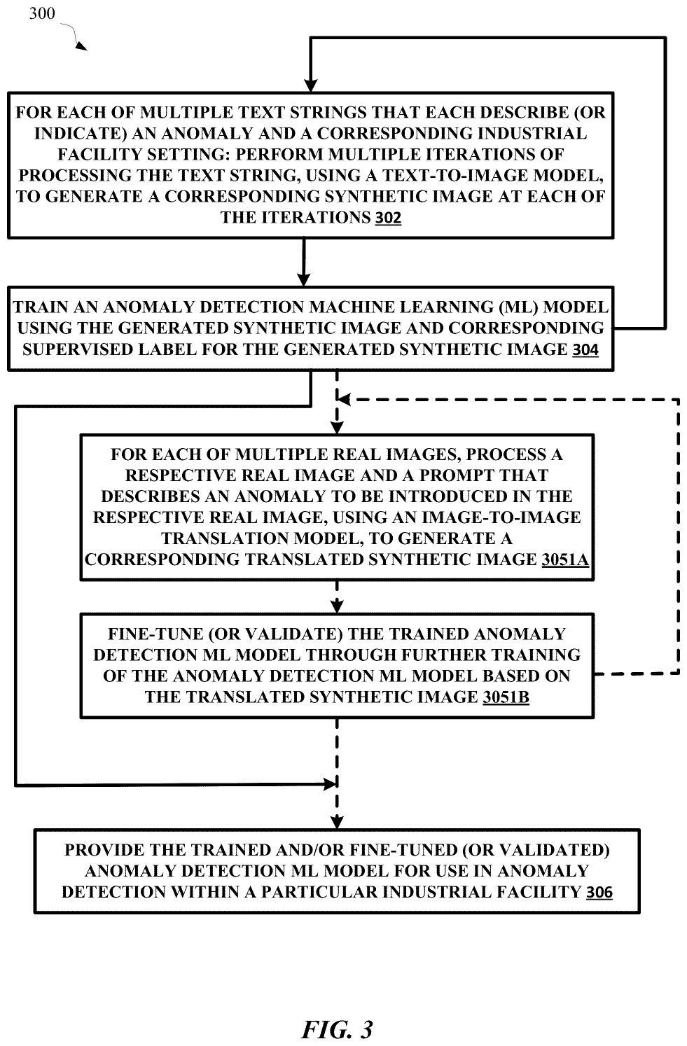

FIG. 3 is a flowchart illustrating an example method 300 of practicing selected aspects of the present disclosure, in accordance with implementations disclosed herein. For convenience, the operations of the flow chart are described with reference to a system that performs the operations. This system can include various components of various computer systems, such as one or more components of the server computing device 105 (and/or additional computing devices such as the client device 103-A), including the ML engine 1051, the anomaly detection engine 1052, and/or the database. Moreover, while operations of method 300 are shown in a particular order, this is not meant to be limiting. One or more operations can be reordered, omitted or added.

At block 302, the system, e.g., by way of a server such as the server computing device 105, may, for each of multiple text strings that each describe (or indicate) an anomaly and a corresponding industrial facility setting: perform multiple iterations of processing the text string, using a text-to-image model, to generate a corresponding synthetic image at each of the iterations. The industrial facility setting can include but is not limited to include, for instance, one or more of: a chemical processing plant, an oil or natural gas refinery, a catalyst factory, a manufacturing facility, an offshore oil platform, or any other applicable facility (which can implement one or more at least partially automated processes).

In some implementations, the system can determine the multiple text strings each describing an anomaly and a corresponding industrial facility setting, prior to performing multiple iterations of processing the text string for each of the multiple text strings. As a non-limiting example, the multiple text strings can include a first text string of “oil spill” stored in association with a first chemical plant (or “oil spill in a chemical plant”), a second text string of “pipe corrosion” stored in association with a second chemical plant (which can be the same as or different from the first chemical plant), and/or a third text string of “broken sensor wire” stored in association with a manufacturing factory.

The first text string, the second text string, the third text string, and/or additional text string(s) can be received from user input or can be retrieved from a database or a file storing/listing text descriptions collected for different anomalies. The database (or the file), for instance, can include a first entry storing the first text string, a second entry storing the second text string, and a third entry storing the third text string. In some implementations, entries of the database can be grouped based on types of the different anomalies, hazardous levels of the different anomalies, industrial facilities at which the different anomalies are respectively foreseeable, and/or historical locations or regions the different anomalies have been witnessed or recorded, etc.

Continuing with the non-limiting example above, given the first text string of “oil spill in a chemical plant”, the first text string can be processed, at a first iteration, as input, using the text-to-image model, to generate an image N_11 (which is a realistic synthetic image) that shows a portion of a chemical plant that reflects oil spill (e.g., on the interior ground of the chemical plant). This way, the first text string of “oil spill in a chemical plant” can be processed repeatedly (e.g., m times/iterations) as input, using the text-to-image model, to generate a set of (e.g., a total number of m) images (e.g., image N_11, image N_12, . . . , image N_1m) respectively reflecting oil spill within a corresponding chemical plant. In some implementations, the generated set of images can be stored (e.g., locally, at a server device, or over cloud) in association with the first text string of “oil spill in a chemical plant” for subsequent use.

For instance, a first training instance can be generated and stored to include image N_11 as training instant input and the first text string of “oil spill in a chemical plant” (or a keyword of “oil spill” which is extracted from the first text string) as a supervised label, a second training instance can be generated and stored to include image N_12 as training instant input and the first text string of “oil spill in a chemical plant” (or a keyword of “oil spill” which is extracted from the first text string) as a supervised label, . . . , and a mth training instance can be generated and stored to include image N_1m (where m is a positive integer greater than or equal to “1”) as training instant input and the first text string of “oil spill in a chemical plant” (or a keyword of “oil spill” which is extracted from the first text string) as a supervised label.

Optionally, prior to storing the first, second, . . . , and mth training instances, e.g., in a database, the first to mth training instances can be examined (e.g., by experts or technicians trained to identify oil spills) to correct/modify the supervised label or remove one or more of the generated training instances (in case an image in a corresponding training instance does not well reflect “oil spill”). In other words, the first text string can be processed to automatically extract a supervised label for the images generated by the text-to-image model that corresponds to the first text string, and one or more supervised labels (if needed) can be verified or modified by experts before a corresponding training instance that includes the supervised label is stored.

Continuing with the non-limiting example above, given the second text string of “pipe corrosion” (or “pipe corrosion in a chemical plant”, or “pipe corrosion in a manufacturing site”, etc.), the second text string can be processed, at a first iteration, as input, using the text-to-image model, to generate an image N_21 (which is a realistic synthetic image) that shows “pipe corrosion” (e.g., on one pipe). Optionally, the second text string of “pipe corrosion” can be processed repeatedly (e.g., p times/iterations) as input, using the text-to-image model, to generate a set of (e.g., a total number of “p”, where p is a positive integer greater than or equal to “1”, “p” can be the same as or different from “m”) images (e.g., image N_21, image N_22, . . . , image N_2p) respectively reflecting pipe corrosion of one or more pipes. Similarly, a total number of p training instances can be generated and/or stored in the aforementioned database, based on the generated set of images (e.g., image N_21, image N_22, . . . , image N_2p) and the second text string of “pipe corrosion”. Repeated descriptions are omitted herein.

At block 304, the system, e.g., by way of a server such as the server computing device 105, can train an anomaly detection machine learning (ML) model using the generated synthetic images and corresponding supervised labels for the generated synthetic images. The anomaly detection ML model can be different from the aforementioned text-to-image model. While the text-to-image model can perform text-to-image translations, the anomaly detection ML model can be a classifier that is utilized to detect one or more anomalies (e.g., to predict probabilities of presence of each of a predefined anomalies in a real-world image within the industrial facility setting), so that proper and prompt remediating actions can be correspondingly performed in response to detection of one of the predefined anomalies. In some implementations, the anomaly detection ML model can be utilized in detecting an anomaly that is not among the anomalies reflected in the synthetic images (which are generated by the text-to-images model based on the multiple text strings), and/or in detecting an anomaly that is not described by the multiple text strings.

In some implementations, the system can, for each of the generated synthetic images, train the anomaly detection ML model by processing a respective synthetic image as input, using the anomaly detection ML model, to generate a output (e.g., classification output) indicating a plurality of likelihoods that each of a predefined number of anomalies existing in the industrial facility setting captured in the respective synthetic image. The output can be compared with a supervised label that corresponds to the respective synthetic image to determine a difference, and based on the determined difference, one or more weights/parameters of the anomaly detection ML model can be adjusted or modified.

It is noted that while the generated synthetic images herein are described for use in training the anomaly detection ML model, the generated synthetic images (or a portion thereof) can be additionally or alternatively applied to fine-tune or validate additional anomaly detection ML model(s). Or, the generated synthetic images can be divided into two or three groups, one used for training the anomaly detection ML model, one used for fine-tuning the anomaly detection ML model, and/or one used for validating anomaly detection ML model, where the group of synthetic images used for training the anomaly detection ML model can have a largest amount of synthetic images among the two or three groups divided from the generated synthetic images.

At block 306, the system, e.g., by way of a server such as the server computing device 105, can provide the trained anomaly detection ML model for use in anomaly detection within a particular industrial facility. For example, one or more vision sensors of the particular industrial facility can be utilized to monitor the particular industrial facility through capturing of images or video(s). Each image (or image frame from the video(s)) or a selected image (or image frame) captured for the particular industrial facility can be processed as input, using the trained anomaly detection ML model, to generate output indicating a name of an anomaly, a likelihood of presence of the anomaly within the particular industrial facility, and/or a location (e.g., highlighted by a bounding box) of the anomaly with respect to the captured image. In response to the output of the trained anomaly detection ML model indicating the presence of an anomaly (e.g., based on the likelihood satisfying a likelihood threshold), one or more remediating actions can be performed. The one or more remediating actions, for instance, can include a first remediating action of generating and delivering a warning message, a second remediating action of pausing or stopping one or more industrial process(es), a third remediating action of cutting of power, etc. It is noted that the one or more remediating actions are not limited to descriptions herein, and different remediating actions can be performed based on a type (or name), a hazardous level, and/or a location (or a size or amount estimated based on the aforementioned output) of the detected anomaly.

In some implementations, the one or more vision sensors can be included in a mobile robot, and the one or more vision sensors can capture image of one or more particular components within the industrial facility setting. The one or more particular components, as a non-limiting example, can include: a liquid tank and/or a liquid the liquid tank carries. The mobile robot can be a quadruped robot (e.g., a robot dog), a wheeled robot, an unmanned aerial vehicle, or any other applicable robot movable within the industrial facility setting.

The one or more vision sensors can include, for instance, a monographic RGB camera, a stereographic camera, a thermal camera, and/or any other applicable vision sensor. The image captured by the vision sensor can correspondingly be a RGB image, a RGB-D image, a thermal image, or any other applicable image. In some implementations, the image can be a high-resolution image. In some implementations, the vision sensor can be integrated with the mobile robot, or can be removably coupled to the mobile robot.

In some implementations, providing the trained anomaly detection ML model for use in anomaly detection within the particular industrial facility includes: causing the trained anomaly detection ML model to be used in processing real images that are captured via a vision sensor that is within or outside the particular industrial facility. In some implementations, the vision sensor can be carried by a mobile robot (a robot dog) that moves around the particular industrial facility. In these implementations, causing the trained anomaly detection ML model to be used in processing real images can include: causing the trained anomaly detection ML model to be downloaded locally to the mobile robot that moves around the particular industrial facility, for constant or scheduled monitoring and detection of anomalies. By having the trained anomaly detection ML model locally at the mobile robot, images captured using the vision sensor of the mobile robot can be processed using the trained anomaly detection ML model for prompt anomaly detection and/or notification.

Additionally or alternatively, causing the trained anomaly detection ML model to be used in processing real images includes: causing the trained anomaly detection ML model to be downloaded to one or more on-site computers (e.g., server(s)). In these implementations, the images captured by the vision sensor are provided to the one or more on-site computers that are within the particular industrial facility, to be processed using the trained anomaly detection ML model that is downloaded to those servers, for anomaly detection.

In some implementations, more than one anomaly detection ML model can be trained, e.g., using one or more steps described throughout this disclosure. The more than one anomaly detection ML model can be stored at a remote server (or can be distributed over one or more remote servers). As a non-limiting example, the more than one anomaly detection ML model can include: a first anomaly detection ML model that is fine-tuned or validated for a first site (e.g., a first industrial facility), and a second anomaly detection ML model that is fine-tuned or validated for a second site different from the first site (e.g., a second industrial facility). Real images captured by sensor(s) of the first site can be forwarded/transmitted to the remote server, for instance, along with an identifier of the first site. Additional real images captured by sensor(s) of the second site can be forwarded/transmitted to the remote server, for instance, along with an identifier of the second site.

In the above non-limiting example, in response to receiving a real image with an identifier of the first site, the first anomaly detection ML model that is fine-tuned or validated for the first site can be accessed and utilized in processing the real image, so that whether anomaly present in the real image is determined. Similarly, in response to receiving an additional real image with an identifier of the second site, the second anomaly detection ML model that is fine-tuned or validated for the second site can be accessed and utilized in processing the additional real image, so that whether anomaly present in the additional real image is determined. Additionally or alternatively, the trained anomaly detection ML model (and/or one or more additionally trained anomaly detection ML models) can be accessed over cloud. For instance, and can be accessed to be used in processing real images includes: causing the trained anomaly detection ML model to be used.

In various implementations, prior to providing the trained anomaly detection ML model for use in anomaly detection within the particular industrial facility and for each of multiple real images of the particular industrial facility, the system may, at block 3051A, process the real image and a prompt that describes the anomaly, using an image-to-image translation model, to generate a corresponding translated synthetic image (e.g., that includes an image representation of the anomaly described in the prompt); and at block 3053A, fine-tune the trained anomaly detection ML model through further training of the anomaly detection ML model based on the translated synthetic images.

By fine-tuning the trained anomaly detection ML model using the translated synthetic images that are generated from real images of the particular industrial facility, one or more weights/parameters of the trained anomaly detection ML model can be fine-tuned and a performance of the trained anomaly detection ML model in detecting anomalies for the particular industrial facility (and/or in detecting certain anomalies) can be improved.

In some implementations, as described previously, the trained anomaly detection ML model can be trained based on a large quantity of diverse synthetic images (e.g., the synthetic images generated by the text-to-image model at the multiple iterations at block 302) each reflecting a corresponding anomaly within the industrial facility setting. In these implementations, the anomalies that are artificially created/introduced in the translated synthetic images (which are derived from real images capturing one or more components or matters within the particular industrial facility) and that are described in the prompts (e.g., at block 3051A) can have little or no overlapping with respect to the anomalies described in the multiple text strings (e.g., at block 302). As a non-limiting example, the multiple text strings can describe anomalies such as “oil spills”, “pipe corrosion”, and “broken wiring”, while the prompts used to condition the real images can describe anomalies (e.g., “water leakage”) specific to the particular industrial facility.

In various implementations, prior to providing the trained anomaly detection ML model for use in anomaly detection within the particular industrial facility and for each of multiple real images of the particular industrial facility, the system may, process the real image and a prompt that describes the anomaly, using an image-to-image translation model, to generate a corresponding translated synthetic image; and validate (or test) the trained anomaly detection ML model based on the translated synthetic images. In these implementations, providing the trained anomaly detection ML model for use in anomaly detection within the particular industrial facility is in response to determining the validating satisfies one or more conditions.

In some implementations, validating the trained anomaly detection ML model based on the translated synthetic images includes: determining an accuracy measure of anomaly predictions made based on outputs, from the anomaly detection ML model, based on processing the translated synthetic images. The one or more conditions can include, for instance, a threshold accuracy measure.

As a non-limiting example, assume fifty translated synthetic images are generated using the image-to-image translation model and the fifty translated synthetic images are used to validate the trained anomaly detection ML model. In this non-limiting example, if forty-two out of fifty outputs of the trained anomaly detection ML model (that correspond to the fifty translated synthetic images) match supervised labels for the corresponding fifty translated synthetic image, which results in an accuracy measure of approximately 0.84 (which satisfies the threshold accuracy measure, e.g., 0.8), the trained anomaly detection ML model can be considered as validated and is ready to be deployed for anomaly monitoring and detection at the particular industrial facility.

The methods described herein or in other aspects of the present disclosure can be performed via one or more processors carried by the mobile robot, or included in one or more computing devices that are separate from the mobile robot and non-attached to the mobile robot. In this case, the real-world images captured by a mobile robot for monitoring anomalies can be transmitted by the mobile robot and identified by the one or more computing devices after being transmitted by the mobile robot, for subsequent use and processing.

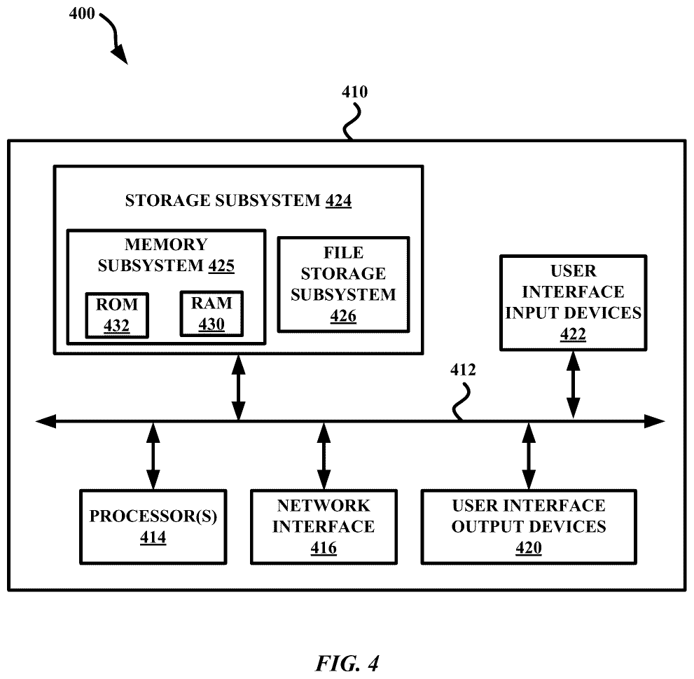

FIG. 4 is a block diagram of an example computing device 410 that can optionally be utilized to perform one or more aspects of techniques described herein. Computing device 410 typically includes at least one processor 414 which communicates with a number of peripheral devices via bus subsystem 412. These peripheral devices can include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 can include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 can include the logic to perform selected aspects of the methods of FIG. 3, as well as to implement various components depicted in FIGS. 1-2.

These software modules are generally executed by processor 414 alone or in combination with other processors. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem can use multiple buses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

What is claimed is:

1. A method implemented by one or more processors, the method comprising:
for each of multiple text strings that each describe an anomaly and a corresponding industrial facility setting:
performing multiple iterations of processing the text string, using a text-to-image model, to generate a corresponding synthetic image at each of the iterations;
training an anomaly detection machine learning (ML) model using the generated synthetic images and corresponding supervised labels for the generated synthetic images; and
providing the trained anomaly detection ML model for use in anomaly detection within a particular industrial facility.

2. The method of claim 1, further comprising:
prior to providing the trained anomaly detection ML model for use in anomaly detection within the particular industrial facility:
for each of multiple real images of the particular industrial facility:
processing the real image and a prompt that describes the anomaly, using an image-to-image translation model, to generate a corresponding translated synthetic image; and
fine-tuning the trained anomaly detection ML model through further training of the anomaly detection ML model based on the translated synthetic images.

3. The method of claim 2, wherein fine-tuning the trained anomaly detection ML model comprises:
fine-tuning weights of one or more layers of the trained anomaly detection ML model.

4. The method of claim 1, further comprising:
prior to providing the trained anomaly detection ML model for use in anomaly detection within the particular industrial facility:
for each of multiple real images of the particular industrial facility:
processing the real image and a prompt that describes the anomaly, using an image-to-image translation model, to generate a corresponding translated synthetic image; and
validating the trained anomaly detection ML model based on the translated synthetic images;
wherein providing the trained anomaly detection ML model for use in anomaly detection within the particular industrial facility is in response to determining the validating satisfies one or more conditions.

5. The method of claim 4,
wherein validating the trained anomaly detection ML model based on the translated synthetic images comprises determining an accuracy measure of anomaly predictions made based on outputs, from the anomaly detection ML model, based on processing the translated synthetic images; and
wherein determining the validating satisfies one or more conditions comprises determining that the accuracy measure satisfies a threshold accuracy measure.

6. The method of claim 1, wherein the multiple text strings include a first text string describing a first anomaly within a first industrial facility setting and a second text string describing a second anomaly within the first industrial facility setting.

7. The method of claim 1, wherein the multiple text strings include one text string describing one anomaly within one industrial facility setting and an additional text string describing the one anomaly within an additional industrial facility setting.

8. The method of claim 1, wherein the corresponding supervised labels for the generated synthetic images are automatically determined based at least on the multiple text strings describing the anomaly.

9. The method of claim 1, wherein providing the trained anomaly detection ML model for use in anomaly detection within the particular industrial facility comprises:
causing the trained anomaly detection ML model to be used in processing real images that are captured via a vision sensor that is within the particular industrial facility.

10. The method of claim 9, further comprising:
using the trained anomaly detection ML model in processing the real images, wherein using the trained anomaly detection ML model in processing the real images comprises:
processing a real image of the real images, using the trained anomaly detection ML model, to generate a model output that indicates whether any anomaly is present in one or more of the components; and
causing one or more remediating actions to be performed in response to the model output indicating that an anomaly is present in one or more of the components.

11. The method of claim 9, wherein the vision sensor is carried by a mobile robot, and the real image is captured by the mobile robot at a designated location within the particular industrial facility.

12. The method of claim 10, wherein the one or more remediating actions include a warning message alerting detection of the anomaly in one or more of the components at the designated location.

13. A method implemented by one or more processors, the method comprising:
for each of multiple real images of a particular industrial facility:
processing the real image and a prompt that describes an anomaly associated with the particular industrial facility, using an image-to-image translation model, to generate a corresponding translated synthetic image; and
fine-tuning a trained anomaly detection ML model through further training of the trained anomaly detection ML model based on the translated synthetic images.

14. The method of claim 13, wherein the trained anomaly detection ML model is previously trained based on one or more real images each capturing a corresponding anomaly.

15. The method of claim 14, wherein the corresponding anomaly is captured using a vision sensor within the particular industrial facility.

16. The method of claim 13, wherein the trained anomaly detection ML model is previously trained based on a multiple synthetic images that respectively depict a realistic scene of a corresponding anomaly in an industrial facility setting, the multiple synthetic images generated using a text-to-image model based on one or more text string each describing an anomaly.

17. A method implemented by one or more processors, the method comprising:
for each of multiple real images of a particular industrial facility:
processing the real image and a prompt that describes an anomaly associated with the particular industrial facility, using an image-to-image translation model, to generate a corresponding translated synthetic image; and
validating a trained anomaly detection ML model based on the translated synthetic images.

18. The method of claim 17, further comprising:
determining whether the validating satisfies one or more conditions; and
in response to determining the validating satisfies the one or more conditions, providing the trained anomaly detection ML model for use in anomaly detection within the particular industrial facility.

19. The method of claim 18, wherein validating the trained anomaly detection ML model based on the translated synthetic images comprises determining an accuracy measure of anomaly predictions made based on outputs, from the anomaly detection ML model, based on processing the translated synthetic images, and wherein the one or more conditions comprise a threshold accuracy measure.

20. The method of claim 17, wherein the trained anomaly detection ML model is previously trained based on multiple synthetic images that respectively depict a realistic scene of a corresponding anomaly in an industrial facility setting, wherein the multiple synthetic images are generated using a text-to-image model based on one or more text strings each describing an anomaly.

21. The method of claim 17, wherein the trained anomaly detection ML model is previously trained based on one or more real images each capturing a corresponding anomaly within an industrial facility setting.
